(19) United States
(12) Patent Application Publication
(10) Pub. No.: US 2014/0059531 A1
(43) Pub. Date: Feb. 27, 2014

(54) METHOD AND APPARATUS FOR UPDATING TERMINAL SOFTWARE

(71) Applicant: Electronics and Telecommunications Research Institute, (US)

(72) Inventors: Young Suk LEE, Gwangju (KR); Hark YOO, Gwangju (KR); Geun Yong KIM, Goyang-si (KR); Mun Seob LEE, Daejeon (KR); Sung Chang KIM, Gwangju (KR); Dong Soo LEE, Seoul (KR); Young Sun KIM, Daejeon (KR)

(73) Assignee: Electronics and Telecommunications Research Institute, Daejeon (KR)

(21) Appl. No.: 13/756,954

(22) Filed: Feb. 1, 2013

(30) Foreign Application Priority Data
Aug. 23, 2012 (KR) 10-2012-0092178

(51) Int. Cl. G06F 9/445

(52) U.S. Cl. CPC G06F 8/65
USPC 717/171

(57) ABSTRACT

Disclosed are a method and apparatus for updating a terminal software version. The method includes providing software update start information including window size information and software image storage space information to a plurality of terminals, receiving first response information in accordance with provision of the software update start information from the plurality of terminals, and providing software update information in accordance with the window size information to the plurality of terminals in units of sections.

### CLAIM FOR PRIORITY

This application claims priority to Korean Patent Application No. 10-2012-0092178 filed on Aug. 23, 2012 in the Korean Intellectual Property Office (KIPO), the entire contents of which are hereby incorporated by reference.

### BACKGROUND

1. Technical Field

Example embodiments of the present invention relate in general to a method and apparatus for updating a terminal software version and more specifically to a method and apparatus for simultaneously updating a plurality of terminal software versions in a passive optical network (PON).

2. Related Art

Channels of communication systems such as conventional telephone networks, mobile communication networks (for example, a 2G mobile communication network such as a global system for mobile communication (GSM) or code division multiple access (CDMA), a 3G mobile communication network such as wideband code division multiple access (WCDMA) or CDMA2000, a 3.5G mobile communication network such as high speed uplink packet access (HSUPA), a 4G mobile communication network such as an LTE-advanced network, or the like), gigabit passive optical networks (GPON), and the like are constituted of control channels and data channels. Of these, a GPON includes an optical line terminal (OLT) that is a communication server and an optical network terminal (ONT) that is a terminal, and the OLT and the ONT are connected in a structure of 1:1 through a control channel, and therefore the OLT performs information management and control with respect to the ONT. In particular, when updating an ONT software version, the ONT software version may be updated using an ONT management control interface (OMCI).

However, since the OLT and the ONT are connected in the structure of 1:1 in the GPON, an update time of the software version is required according to the number of ONTs when updating the ONT software version. For example, when an update time of a single ONT software version is 3 minutes, 30 minutes are required for updating 10 ONT software versions.

In particular, in a network having a structure of 1:N like a GPON, a considerable amount of time of 768 minutes (256×3 minutes) is required in order to update all ONT software versions when a single network is formed by 256 ONTs, and therefore there is a demand for technology for simultaneously updating a plurality of ONT software versions.

In addition, when re-transmission is required due to transmission failure of software images while updating the ONT software version, re-transmission in units of segments may be made possible, but re-transmission in units of sections may be made impossible, that is, a segment itself including a single section should be re-transmitted even when transmission of the single section has failed, and therefore more time is consumed when updating the ONT software version.

### SUMMARY

Accordingly, example embodiments of the present invention are provided to substantially obviate one or more problems due to limitations and disadvantages of the related art.

Example embodiments of the present invention provide a method for simultaneously updating a plurality of terminal software versions.

Example embodiments of the present invention also provide an apparatus for simultaneously updating a plurality of terminal software versions.

In some example embodiments, a method for updating a terminal software version performed in a communication server includes: providing software update start information including window size information and software image storage space information to a plurality of terminals; receiving first response information in accordance with provision of the software update start information from the plurality of terminals; and providing software update information in accordance with the window size information to the plurality of terminals in units of sections.

Here, the providing of the software update start information may include providing the software update start information to the plurality of terminals based on a broadcast or multicast scheme.

Here, the providing of the software update information may include providing a software image as the software update information to the plurality of terminals based on a broadcast or multicast scheme.

Here, the method may further include receiving second response information in accordance with provision of the software image from the plurality of terminals; providing software image activation request information to the plurality of terminals when transmission of the software image is completed; receiving third response information in accordance with the software image activation request information from the plurality of terminals; and providing software update termination information to the plurality of terminals.

Here, the method may further include: receiving second response information in accordance with provision of the software image from the plurality of terminals; and providing, when transmission failure information is included in the second response information, a software image corresponding to the transmission failure information to the terminal that provides the transmission failure information in a unicast scheme.

Here, the providing of the software image may include providing the software image in units of section whose transmission has failed, in the unicast scheme.

In other example embodiments, a method for updating a terminal software version performed in a terminal includes: receiving software update start information including window size information and software image storage space information from a communication server; providing first response information in accordance with reception of the software update start information to the communication server; and receiving a software image in accordance with the window size information from the communication server.

Here, the providing of the first response information may include providing the first response information to the communication server after setting a window size and a software image storage space based on the software update start information.

Here, the method may further include providing, when reception of the software image has failed, transmission failure information to the communication server; and receiving the software image corresponding to the transmission failure information from the communication terminal in a unicast scheme.

In other example embodiments, a communication server includes: a processing unit that generates software update start information including window size information and software image storage space information, and forms a software image based on the window size information; and a transmission unit that provides the software update start information to a plurality of terminals, receives first response information in accordance with provision of the software update start information from the plurality of terminals, and provides the software image in accordance with reception of the first response information to the plurality of terminals.

Here, the transmission unit may provide the software update start information and the software image to the plurality of terminals based on a broadcast or multicast scheme.

Here, the transmission unit may receive second response information in accordance with provision of the software image from the plurality of terminals, and provide, when transmission failure information is included in the second response information, the software image corresponding to the transmission failure information to the terminal that provides the transmission failure information, based on a unicast scheme.

In other example embodiments, a terminal includes: a transmission unit that receives software update start information including window size information and software image storage space information from a communication server, provides first response information in accordance with reception of the software update start information to the communication server, and receives a software image in accordance with provision of the first response information from the communication server; and a processing unit that sets a window size and a software image storage space based on the software update start information, and stores the received software image in the software image storage space.

Here, the transmission unit may provide, when reception of the software image has failed, transmission failure information to the communication server, and receive the software image corresponding to the transmission failure information from the communication terminal in a unicast scheme.

### BRIEF DESCRIPTION OF DRAWINGS

Example embodiments of the present invention will become more apparent by describing in detail example embodiments of the present invention with reference to the accompanying drawings, in which:

FIG. 1 is a block diagram showing a configuration of a gigabit passive optical network (GPON);

FIG. 2 is a block diagram showing a format of an ONT management control interface (OMCI) packet;

FIG. 3 is a conceptual diagram showing a software image transmitted in a GPON;

FIG. 4 is a flowchart showing a method for updating a terminal software version in a GPON;

FIG. 5 is a flowchart showing a method for updating terminal software according to an embodiment of the present invention;

FIG. 6 is a block diagram showing a configuration of a communication server that is an apparatus for updating a terminal software version according to an embodiment of the present invention; and

FIG. 7 is a block diagram showing a configuration of a terminal that is an apparatus for updating a terminal software version according to an embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise” It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Hereinafter, preferred embodiments of the present invention will be described in detail with reference to the accompanying drawings.

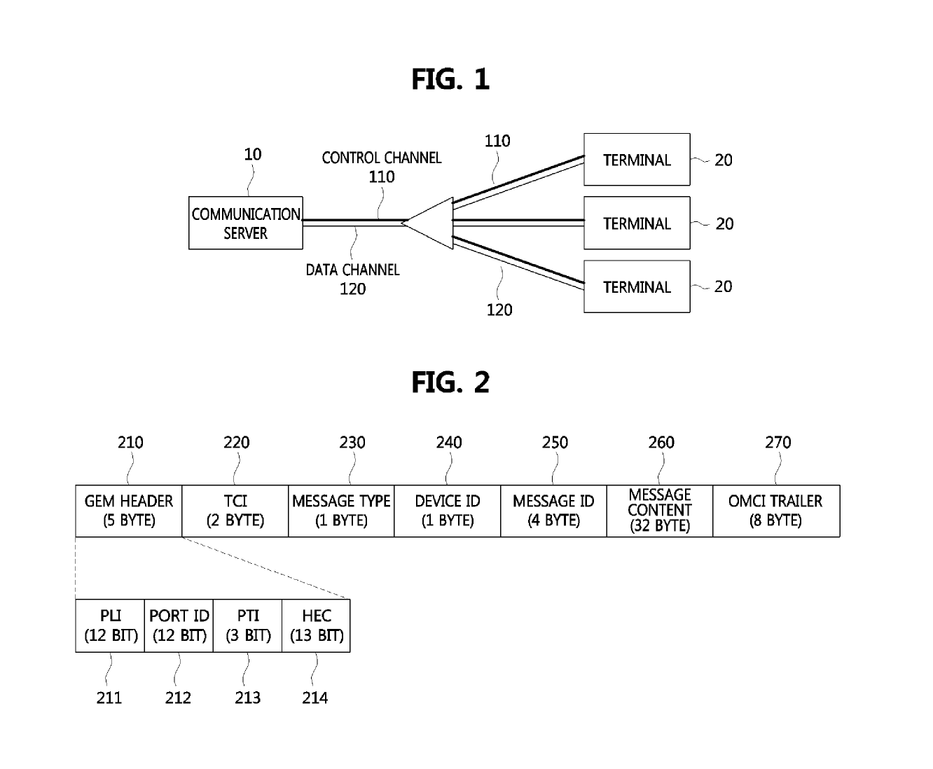

FIG. 1 is a block diagram showing a configuration of a gigabit passive optical network (GPON).

Referring to FIG. 1, GPON includes a communication server 10 and a plurality of terminals 20. Here, the communication server 10 denotes an optical link terminal (OLT), and the terminal 20 denotes an optical network terminal (ONT). The communication server 10 and each of the terminals 20 exchange packets through a control channel 110 and a data channel 120, and are connected with each other in a structure of 1:1 through the control channel 110 and the data channel 120.

FIG. 2 is a block diagram showing a format of an ONT management control interface (OMCI) packet.

Referring to FIG. 2, a protocol data unit (PDU) of the OMCI packet has a size of 53 bytes, and includes a gigabit-capable passive optical network encapsulation method (GEM) header 210, a transaction correlation identifier (TCI) 220, a message type 230, a device identifier 240, a message identifier 250, message contents 260, and an OMCI trailer 270.

The GEM heater 210 includes a payload length indicator (PLI) 211, a port identifier (ID) 212, a payload type indicator (PTI) 213, and a header error correction (HEC) 214.

Here, the port ID 212 is an ID for identifying each of terminals, and the communication server 10 may transmit an OMCI packet to a specific terminal 20 corresponding to ID of the port ID 212. Here, when the ID of the port ID 212 designates all of the terminals 20 (for example, the port ID 212 is null), the communication server 10 may transmit the OMCI packet to all of the terminals 20.

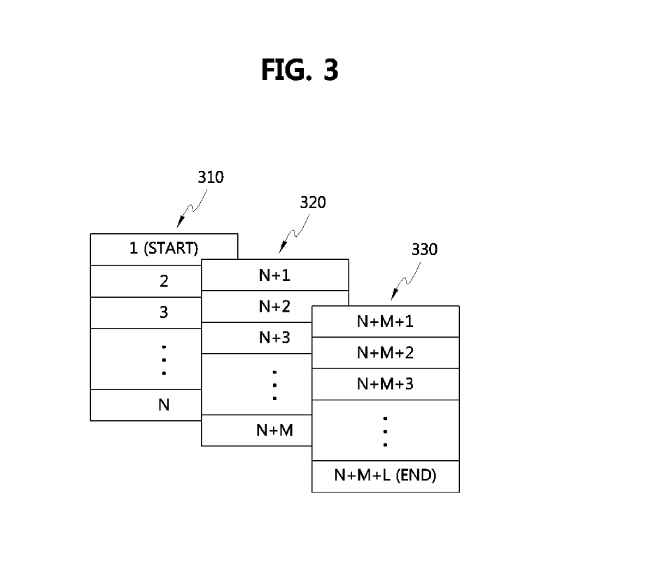

FIG. 3 is a conceptual diagram showing a software image transmitted in a GPON.

Referring to FIG. 3, the software image may be divided into at least one segment, and the segment may be divided into at least one section. Here, the software image may be divided into a first section (1 to N) 310, a second section (N+1 to N+M) 320, and a third section (N+M+1 to N+M+L) 330.

Here, the software image may denote firmware, and for example, an operating system program installed in a terminal, or other various application programs may correspond to the software image.

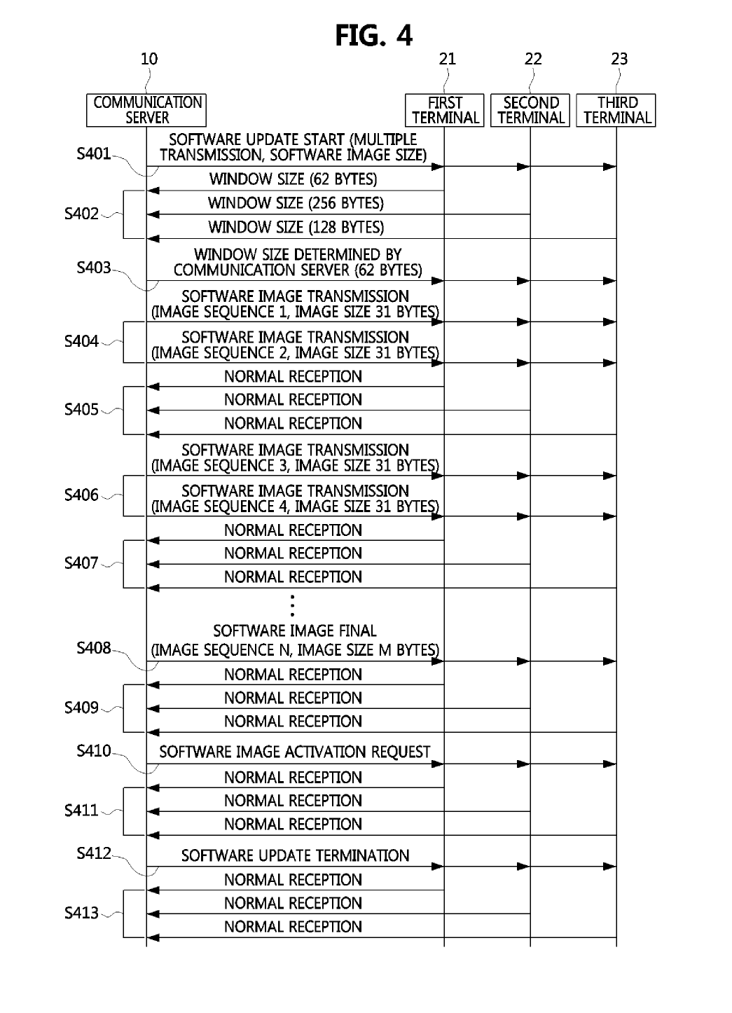

FIG. 4 is a flowchart showing a method for updating a terminal software version in a GPON.

Referring to FIG. 4, in step S401, the communication server 10 may provide software update start information to a plurality of terminals 21, 22, and 23, and more specifically, provide the software update start information to the plurality of terminals 21, 22, and 23 using a multiple transmission method such as broadcast or multicast.

In this instance, the communication server 10 may set the port ID of the GEM header as “65534,” and provide the software update start information to the plurality of terminals 21, 22, and 23 based on the set port ID in the multiple transmission method. Here, the software update start information may include software image size information and version information, and further include software image storage information.

In step S402, each of the terminals 21, 22, and 23 may receive the software update start information provided through step S401, and provide window size information in accordance with the received software update start information to the communication server 10.

First, each of the terminals 21, 22, and 23 may determine whether the version information included in the software update start information corresponds to up-to-date information. When the version information is the up-to-date information (for example, when version information with respect to the software image included in the software update start information is more up-to-date information than version information with respect to the software images of the terminals 21, 22, and 23), each of the terminals 21, 22, and 23 may provide window size information to the communication server 10. When the version information is not the up-to-date information (for example, when the version information with respect to the software image of the terminals 21, 22, and 23 is more up-to-date information than version information with respect to the software image included in the software update start information), each of the terminals 21, 22, and 23 may provide update failure information to the communication server 10.

Here, the window size may denote a size of a section which is transmitted and received between the communication server 10 and the terminals 21, 22, and 23 without ACK singles, and the window size with respect to each of the terminals 21, 22, and 23 may denote a window size that can be processed by each of the terminals 21, 22, and 23.

For example, when the window size that can be processed by a first terminal 21 is 62 bytes, the first terminal 21 may notify the communication server 10 that the first terminal 21 can process the window with a size of 62 bytes. When the window size that can be processed by a second terminal 22 is 256 bytes, the second terminal 22 may notify the communication server 10 that the second terminal 22 can process the window with a size of 256 bytes. When the window size that can be processed by a third terminal 23 is 128 bytes, the third terminal 23 may notify the communication server 10 that the third terminal 23 can process the window with a size of 128 bytes.

In step S402, each of the terminals 21, 22, and 23 may set a space for storing the software image based on software image storage space information included in the software update start information.

In step S403, the communication server 10 may receive the window size information provided through step S402, and provide window size information to be used in transmission of the software image based on the received window size information to the plurality of terminals 21, 22, and 23. Here, the communication server 10 may provide the window size information to be used in the transmission of the software image using a multiple transmission method such as broadcast or multicast.

In this instance, since the communication server 10 is aware of the number of terminals connected to the communication server, the communication server 10 may compare a sum of the number of pieces of the received window size information and the number of pieces of the update failure information and the number of the terminals connected to the communication server 10 (that is, “the number of pieces of window size information+the number of pieces of update failure information”=“the number of terminals connected to communication server” ?), select the smallest window size information among the window size information received from the plurality of terminals 21, 22, and 23 when “the number of pieces of window size information+the number of pieces of update failure information”=“the number of terminals connected to communication server” is satisfied based on the compared result, and provide the selected window size information (that is, window size information to be used in transmission of software image).

For example, when the window size that can be processed by the first terminal 21 is 62 bytes, the window size that can be processed by the second terminal 22 is 256 bytes, and the window size that can be processed by the third terminal 23 is 128 bytes, the communication server 10 may select 62 bytes that is the smallest window size as the window size information to be used in the transmission of the software image.

In step S404, after providing the window size information to be used in the transmission of the software image to the plurality of terminals 21, 22, and 23, the communication server 10 may provide the software image to the plurality of terminals 21, 22, and 23. Here, the communication server 10 may provide the software image to the plurality of terminals 21, 22, and 23 using the multiple transmission method such as broadcast or multicast. In this instance, the communication server 10 may sequentially provide the software image to the plurality of terminals 21, 22, and 23 starting from a first section.

In step S405, each of the terminals 21, 22, and 23 may receive the software image through step S404, and provide reception response information to the communication server 10 depending on whether the received software image is normal. For example, the terminal that receives the software image in a normal manner may provide normal reception response information to the communication server 10, and the terminal that does not receive the software image in the normal manner may provide reception failure response information to the communication server 10.

In step S406, the communication server 10 may receive the reception response information provided through step S405, and when receiving the normal reception response information from all of the terminals 21, 22, and 23, provide the software image corresponding to the following section to the plurality of terminals 21, 22, and 23. Here, the communication server 10 may provide the software image to the plurality of terminals 21, 22, and 23 using the multiple transmission method such as broadcast or multicast.

In step S407, each of the terminals 21, 22, and 23 may receive the software image provided through step S406, and provide the reception response information to the communication server 10 depending on whether the received software image is normal. For example, the terminal that receives the software image in the normal manner may provide the normal reception response information to the communication server 10, and the terminal that does not receive the software image in the normal manner may provide the reception failure response information to the communication server 10.

Thereafter, the communication server 10 and the plurality of terminals 21, 22, and 23 may perform steps 406 and 407 until the final software image is transmitted and received.

In step S408, the communication server 10 may provide the final software image to the plurality of terminals 21, 22, and 23. In this instance, the communication server 10 may notify the plurality of terminals 21, 22, and 23 that the software image corresponds to the final software image. Here, the communication server 10 may provide the final software image to the plurality of terminals 21, 22, and 23 using the multiple transmission method such as broadcast or multicast.

In step S409, each of the terminals 21, 22 and 23 may receive the final software image through step S408, and provide reception response information to the communication server 10 depending on whether the received software image is normal. For example, the terminal that receives the software image in a normal manner may provide normal reception response information to the communication server 10, and the terminal that does not receive the software image in the normal manner may provide reception failure response information to the communication server 10.

In step S410, the communication server 10 may receive the reception response information provided through step S409, and when receiving the normal reception response information from all of the terminals 21, 22 and 23, may provide software image activation request information for application of new software to the plurality of terminals 21, 22, and 23. Here, the communication server 10 may provide the software image activation request information to the plurality of terminals 21, 22, and 23 using the multiple transmission method such as broadcast or multicast.

In step S411, each of the terminals 21, 22, and 23 may receive the software image activation request information through step S410, and provide reception response information in accordance with the received software image activation request information to the communication server 10.

In step S412, the communication server 10 may receive the reception response information provided through step S411, and when receiving the reception response information from all of the terminals 21, 22, and 23, provide software update termination information to the plurality of terminals 21, 22, and 23. Here, the communication server 10 may provide the software update termination information to the plurality of terminals 21, 22, and 23 using the multiple transmission method such as broadcast or multicast.

In step S413, each of the terminals 21, 22, and 23 may receive the software update termination information provided through step S412, and provide reception response information in accordance with the received software update termination information to the communication server 10.

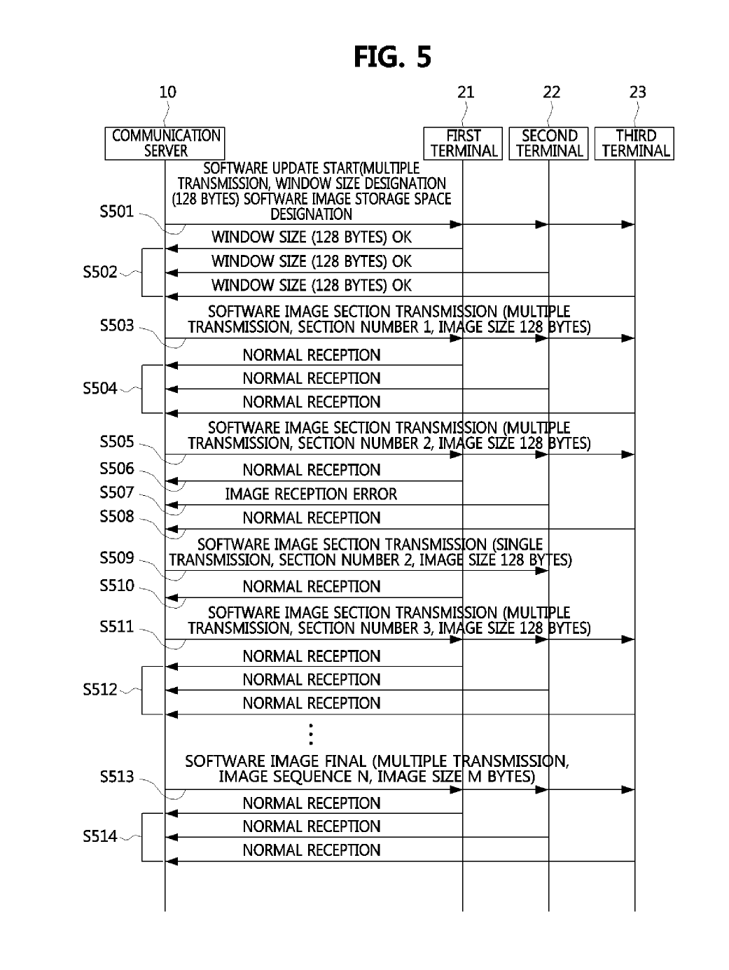

FIG. 5 is a flowchart showing a method for updating terminal software according to an embodiment of the present invention.

Referring to FIG. 5, in step S501, the communication server 10 may provide software update start information to a plurality of terminals 21, 22, and 23, and more specifically provide the software update start information to the plurality of terminals 21, 22, and 23 using a multiple transmission method such as broadcast or multicast.

In this instance, the communication server 10 may set a port ID of a GEM header as “65534,” and provide software update start information to the plurality of terminals 21, 22, and 23 in the multiple transmission method based on the set port ID.

Here, the software update start information may include window size information and software image storage space information, and may further include software image size information and version information. The window size information included in the software update start information may be information that is set in advance by the communication server 10. For example, the communication server 10 may set the window size as 128 bytes, and provide the set window size information to the plurality of terminals 21, 22, and 23.

Each of the terminals 21, 22 and 23 may receive the software update start information through step S501, and provide reception response information in accordance with the received software update start information to the communication server 10. Each of the terminals that receive the software update start information may set a window size in accordance with the window size information included in the software update start information, and set a space for storing the software image in accordance with the software image storage space information included in the software update start information. For example, when the window size information included in the software update start information is set as 128 bytes, each of the terminals 21, 22, and 23 may set the window size as 128 bytes.

In this manner, after setting the space for storing the window size and the software image, each of the terminals 21, 22 and 23 may provide reception response information in accordance with software update start request information to the communication server 10.

Meanwhile, when the version information is included in the software update start information, each of the terminals 21, 22 and 23 may determine whether the version information included in the software update start information corresponds to up-to-date information. When the version information is the up-to-date information (for example, when version information with respect to the software image included in the software update start information is more up-to-date information than version information with respect to the software images of the terminals 21, 22, and 23), each of the terminals 21, 22, and 23 may provide the reception response information to the communication server 10. When the version information is not the up-to-date information (for example, when version information with respect to software image of the terminals 21, 22, and 23 is more up-to-date information than version information with respect to software image included in software update start information), each of the terminals 21, 22, and 23 may provide the reception response information including update failure information to the communication server 10.

In step S503, the communication server 10 may receive the reception response information through step S502, and provide, to the plurality of terminals 21, 22, and 23, a software image formed based on the window size information set in advance after receiving the reception response information from the terminals 21, 22, and 23. Here, the communication server 10 may provide the software image to the plurality of terminals 21, 22, and 23 using the multiple transmission method such as broadcast or multicast. In this instance, the communication server 10 may sequentially provide the software image starting from a first section to the plurality of terminals 21, 22, and 23.

In step S504, each of the terminals 21, 22, and 23 may receive the software image through step S503, and provide reception response information to the communication server 10 depending on whether the received software image is normal. That is, the terminal that receives the software image in a normal manner may provide normal reception response information to the communication server 10, and the terminal that does not receive the software image in the normal manner may provide reception failure response information to the communication server 10.

In step S505, the communication server 10 may receive the reception response information provided through step S504, and when receiving normal reception response information from all of the terminals 21, 22, and 23, provide a software image corresponding to the following section to the plurality of terminals 21, 22, and 23. Here, the communication server 10 may provide the software image to the plurality of terminals 21, 22, and 23 using the multiple transmission method such as broadcast or multicast.

In steps S506, S507, and S508, each of the terminals 21, 22, and 23 may receive the software image provided through step S505, and provide reception response information to the communication server 10 depending on whether the received software image is normal. That is, the terminal that receives the software image in a normal manner may provide normal reception response information to the communication server 10, and the terminal that does not receive the software image in the normal manner may provide reception failure response information to the communication server 10.

For example, when the first terminal 21 and the third terminal 23 receive the software image in the normal manner and the second terminal 22 does not receive the software image in the normal manner, the first terminal 21 may provide the normal reception response information to the communication server 10 in step S506, the second terminal 22 may provide the reception failure response information to the communication server 10 in step S507, and the third terminal 23 may provide the normal reception response information to the communication server 10 in step S508.

In step S509, the communication server 10 may receive the reception response information provided through steps S506, S507, and S508, and when the reception failure response information is included in the reception response information, provide, to the second terminal 22 that provides the reception failure response information provided through steps S506, S507, and S508, the software image (that is, software image provided through step S505) that fails in the reception, in a unicast scheme.

In step S510, the second terminal 22 may receive the software image re-transmitted through step S509, and when receiving the software image in the normal manner, provide normal reception response information to the communication server 10. Meanwhile, when failing to receive the re-transmitted software image in the normal manner, the second terminal 22 may provide reception failure response information to the communication server 10, and the communication server 10 that receives the reception failure response information may provide a corresponding software image to the second terminal 22.

In step S511, the communication server 10 may receive the normal reception response information through step S510, and provide a software image corresponding to the following section to the plurality of terminals 21, 22, and 23. Here, the communication server 10 may provide the software image to the plurality of terminals 21, 22, and 23 using the multiple transmission method such as broadcast or multicast.

In step S512, each of the terminals 21, 22, and 23 may receive the software image provided through step S511, and provide reception response information to the communication server 10 depending on whether the received software image is normal. For example, the terminal that receives the software image in a normal manner may provide the normal reception response information to the communication server 10, and the terminal that does not receive the software image in the normal manner may provide the reception failure response information to the communication server 10.

Thereafter, the communication server 10 and the plurality of terminals 21, 22, and 23 may perform steps S503 to S512 depending on whether the received software image is normal.

In step S513, the communication server 10 may provide the final software image to the plurality of terminals 21, 22, and 23. In this instance, the communication server 10 may notify the plurality of terminals 21, 22, and 23 that the software image corresponds to the final software image. Here, the communication server 10 may provide the final software image to the plurality of terminals 21, 22, and 23 using the multiple transmission method such as broadcast or multicast.

In step S514, each of the terminals 21, 22, and 23 may receive the final software image through step S513, and provide the reception response information to the communication server 10 depending on whether the received software image is normal. For example, the terminal that receives the software image in a normal manner may provide the normal reception response information to the communication server 10, and the terminal that does not receive the software image in the normal manner may provide the reception failure response information to the communication server 10.

The communication server 10 may receive the reception response information provided through step S514, and when receiving the normal reception response information from all of the terminals 21, 22, and 23, provide software image activation request information for application of new software to the plurality of terminals 21, 22, and 23 (that is, the same as step S410 of FIG. 4). Here, the communication server 10 may provide the software image activation request information to the plurality of terminals 21, 22, and 23 using the multiple transmission method such as broadcast or multicast.

Each of the terminals 21, 22, and 23 may receive the software image activation request information provided from the communication server 10, and provide the reception response information in accordance with the received software image activation request information to the communication server 10 (that is, the same as S411 of FIG. 4).

The communication server 10 may receive the reception response information in accordance with the software image activation request information from each of the terminals 21, 22, and 23, and when receiving the reception response information from the terminals 21, 22, and 23, provide software update termination information to the plurality of terminals 21, 22, and 23 (that is, the same as step S412 of FIG. 4). Here, the communication server 10 may provide the software update termination information to the plurality of terminals 21, 22, and 23 using the multiple transmission method such as broadcast or multicast.

Each of the terminals 21, 22, and 23 may receive the software update termination information provided from the communication server 10, and provide the reception response information in accordance with the software update termination information to the communication server 10 (that is, the same as step S413 of FIG. 4).

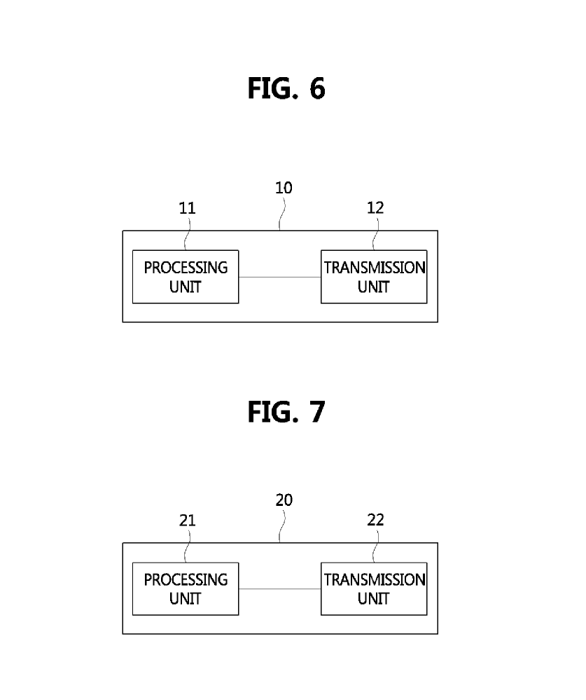

FIG. 6 is a block diagram showing a configuration of a communication server that is an apparatus for updating a terminal software version according to an embodiment of the present invention.

Referring to FIG. 6, the communication server 10 may include a processing unit 11 and a transmission unit 12. The processing unit 11 may generate software update start information including window size information and software image storage space information, and form a software image based on the window size information. Here, the processing unit 11 may generate the software update start information further including software image size information and version information as well as the window size information and the software image storage space information.

The transmission unit 12 may provide the software update start information to a plurality of terminals, receive first response information from the plurality of terminals in accordance with provision of the software update start information, and provide a software image to the plurality of terminals in accordance with reception of the first response information.

The transmission unit 12 may provide the software update start information and the software image to the plurality of terminals based on a broadcast or multicast scheme.

The transmission unit 12 may receive second response information from the plurality of terminals in accordance with provision of the software image, and when transmission failure information is included in the second response information, provide the software image corresponding to the transmission failure information to the terminal that provides the transmission failure information.

FIG. 7 is a block diagram showing a configuration of a terminal that is an apparatus for updating a terminal software version according to an embodiment of the present invention.

Referring to FIG. 7, a terminal 20 may include a processing unit 21 and a transmission unit 22. The transmission unit 22 may receive software update start information including window size information and software image storage space information from a communication server, provide first response information in accordance with reception of the software update start information to the communication server, and receive a software image in accordance with provision of the first response information from the communication server. Here, the software update start information may further include software image size information and version information as well as the window size information and the software image storage space information.

The transmission unit 22 may receive the software update start information and the software image from the communication terminal using the multiple transmission method such as broadcast or multicast, and provide first response information to the communication terminal in a unicast scheme.

When reception of the software image fails, the transmission unit 22 may provide transmission failure information to the communication server, and receive a software image corresponding to the transmission failure information from the communication terminal in a unicast scheme.

The processing unit may set a window size based on the window size information included in the software update start information, and set a software image storage space based on the software image storage space information included in the software update start information.

As described above, according to the embodiments of the present invention, since the software update start information (including window size information and software image storage space information) and the software image may be simultaneously transmitted to a plurality of terminals, it is possible to simultaneously update a plurality of terminal software versions, thereby reducing a time required for updating the plurality of terminal software versions.

In addition, since the software may be updated based on the window size set by the communication server, it is possible to perform a software update process under a communication server's leadership.

In addition, when re-transmission is required due to transmission failure of the software image while updating the terminal software, re-transmission may be performed in units of sections, thereby reducing a time required for updating the terminal software compared to re-transmission in units of segments in the related art.

According to an embodiment of the present invention, the above-described method may be implemented as a computer-readable code in a medium on which a program is recorded. A computer-readable medium includes all types of recording devices on which data that can be read by a computer system is stored. Examples of the computer-readable medium include a ROM, a RAM, a CD-ROM, a magnetic tape, a floppy disk, an optical data storage device, or the like, as well as a device that is implemented in the form of carrier waves (for example, transmission through the Internet). In addition, the computer may include a control unit of a mobile terminal.

While the example embodiments of the present invention and their advantages have been described in detail, it should be understood that various changes, substitutions and alterations may be made herein without departing from the scope of the invention.

What is claimed is:

1. A method for updating a terminal software version performed in a communication server, the method comprising:
providing software update start information including window size information and software image storage space information to a plurality of terminals;
receiving first response information in accordance with provision of the software update start information from the plurality of terminals; and
providing software update information in accordance with the window size information to the plurality of terminals in units of sections.

2. The method of claim 1, wherein the providing of the software update start information includes providing the software update start information to the plurality of terminals based on a broadcast or multicast scheme.

3. The method of claim 1, wherein the providing of the software update information includes providing a software image as the software update information to the plurality of terminals based on a broadcast or multicast scheme.

4. The method of claim 3, further comprising:
receiving second response information in accordance with provision of the software image from the plurality of terminals;
providing software image activation request information to the plurality of terminals when transmission of the software image is completed;
receiving third response information in accordance with the software image activation request information from the plurality of terminals; and
providing software update termination information to the plurality of terminals.

5. The method of claim 3, further comprising:
receiving second response information in accordance with provision of the software image from the plurality of terminals; and
providing, when transmission failure information is included in the second response information, a software image corresponding to the transmission failure information to the terminal that provides the transmission failure information in a unicast scheme.

6. The method of claim 5, wherein the providing of the software image includes providing the software image in units of section whose transmission has failed, in the unicast scheme.

7. A method for updating a terminal software version performed in a terminal, the method comprising:
receiving software update start information including window size information and software image storage space information from a communication server;
providing first response information in accordance with reception of the software update start information to the communication server; and
receiving a software image in accordance with the window size information from the communication server.

8. The method of claim 7, wherein the providing of the first response information includes providing the first response information to the communication server after setting a window size and a software image storage space based on the software update start information.

9. The method of claim 7, further comprising:
providing, when reception of the software image has failed, transmission failure information to the communication server; and
receiving the software image corresponding to the transmission failure information from the communication terminal in a unicast scheme.

10. A communication server comprising:
a processing unit that generates software update start information including window size information and software image storage space information, and forms a software image based on the window size information; and
a transmission unit that provides the software update start information to a plurality of terminals, receives first response information in accordance with provision of the software update start information from the plurality of terminals, and provides the software image in accordance with reception of the first response information to the plurality of terminals.

11. The communication server of claim 10, wherein the transmission unit provides the software update start information and the software image to the plurality of terminals based on a broadcast or multicast scheme.

12. The communication server of claim 10, wherein the transmission unit receives second response information in accordance with provision of the software image from the plurality of terminals, and provides, when transmission failure information is included in the second response information, the software image corresponding to the transmission failure information to the terminal that provides the transmission failure information, based on a unicast scheme.
